(19) United States
(12) Patent Application Publication
(10) Pub. No.: US 2014/0368628 A1
(43) Pub. Date: Dec. 18, 2014

(54) WARNING METHOD FOR DRIVING VEHICLE AND ELECTRONIC APPARATUS FOR VEHICLE

(71) Applicant: UTECHZONE CO., LTD., New Taipei City (TW)

(72) Inventors: Chia-Chun Tsou, New Taipei City (TW); Yun-Yang Lai, New Taipei City (TW); Po-Tsung Lin, New Taipei City (TW); Ting-Yuan Yeh, New Taipei City (TW)

(73) Assignee: UTECHZONE CO., LTD., New Taipei City (TW)

(21) Appl. No.: 14/048,045

(22) Filed: Oct. 8, 2013

(30) Foreign Application Priority Data
Jun. 14, 2013 (TW) 102121147

(51) Int. Cl. G06K 9/00

(52) U.S. Cl. CPC G06K 9/00845
USPC 348/77

(57) ABSTRACT

A warning method for driving a vehicle and an electronic apparatus for a vehicle are provided. An image sequence of a driver is successively captured by an image capturing unit. An ear side location region on a face object is detected in each image of the image sequence. And a moving trace of a target object is detected in each image of the image sequence. A reminding signal is sent when the moving trace moves toward the ear side location region.

### CROSS-REFERENCE TO RELATED APPLICATION

This application claims the priority benefit of Taiwan application serial no. 102121147, filed on Jun. 14, 2013. The entirety of the above-mentioned patent application is hereby incorporated by reference herein and made a part of this specification.

### BACKGROUND OF THE INVENTION

1. Field of the Invention

The invention relates to a warning mechanism, and more particularly, to a warning method for driving a vehicle and an electronic apparatus for a vehicle based on image recognition technology.

2. Description of Related Art

Advances in transportation have promoted urban growth. However, traffic accidents resulting from wrongful driver behavior while operating a means of transport seem to have become the main cause of putting social security in jeopardy. For example, more and more car drivers use a mobile phone while driving since the mobile phone has become an indispensable electronic product in modern lives. Once the driver has to hold the mobile phone in their hand while driving, they can be easily distracted, thus increasing the possibility of causing a traffic accident. Therefore, how to monitor driver behavior timely and effectively and how to alert a driver to the danger of wrongful behavior through a security system are issues which must be addressed in this field.

### SUMMARY OF THE INVENTION

The invention provides a warning method for driving a vehicle and an electronic apparatus for a vehicle to determine whether a driver is using a mobile device by means of image recognition technology.

The warning method for driving a vehicle of the invention is utilized in an electronic apparatus for a vehicle. The method includes the following steps. An image sequence of a driver is successively captured by an image capturing unit. An ear side location region on a face object is detected in each image of the image sequence. A target object is detected in each image of the image sequence. A moving trace of the target object is calculated according to the image sequence. When the moving trace moves toward the ear side location region, a reminding signal is sent.

In an embodiment of the invention, the step of detecting the ear side location region on the face object in each image of the image sequence includes a step of obtaining the face object by means of a face recognition algorithm, a step of searching for a nostrils object on the face object, and a step of searching for the ear side location region in a horizontal direction based on a location of the nostrils object.

In an embodiment of the invention, the step of calculating the moving trace of the target object according to the image sequence includes a step of calculating a vertical projection amount and a horizontal projection amount of the target object to obtain an object region of the target object, a step of selecting a reference point within the object region, and a step of obtaining the moving trace by means of a location of the reference point in each image of the image sequence.

In an embodiment of the invention, when the moving trace moves toward the ear side location region, whether a residence time during which the target object stays in the ear side location region exceeds a predetermined time is also determined. Also, when the residence time exceeds the predetermined time, the reminding signal is sent.

In an embodiment of the invention, the step of detecting the target object includes a step of obtaining a region of interest (ROI) according to the ear side location region, a step of performing an image subtraction algorithm on the ROI in each of a current image and a reference image in the image sequence to obtain a target region image, and a step of filtering out noise in the target region image by means of the ROI in the reference image to obtain the target object.

In an embodiment of the invention, the step of filtering out noise in the target region image by means of the ROI in the reference image to obtain the target object includes a step of performing an edge detection algorithm and a dilation algorithm on the ROI in the reference image to obtain a filtered region image, and a step of performing the image subtraction algorithm on the filtered region image and the target region image to obtain the target object.

The electronic apparatus for a vehicle of the invention includes: an image capturing unit successively capturing an image sequence of a driver, a storage unit storing the image sequence, and a processing unit coupled to the storage unit to obtain the image sequence and also configured to perform an image processing module. The image processing module detects an ear side location region on a face object in each image of the image sequence, detects a target object in each image of the image sequence, calculates a moving trace of the target object, determines whether the target object moves toward the ear side location region based on the moving trace, and sends a reminding signal when the moving trace moves toward the ear side location region.

In an embodiment of the invention, the image processing module includes: an ear detection module detecting the ear side location region on the face object in each image of the image sequence, a target detection module detecting the target object in each image of the image sequence, a trace calculation module calculating the moving trace of the target object, a determination module determining whether the target object moves toward the ear side location region based on the moving trace, and a reminding module sending a reminding signal when the moving trace moves toward the ear side location region.

In an embodiment of the invention, the image processing module further includes: a face identification module obtaining the face object by means of a face recognition algorithm, and searching for a nostrils object on the face object. In addition, the ear detection module further searches for the ear side location region in a horizontal direction based on a location of the nostrils object.

In an embodiment of the invention, the trace calculation module calculates a vertical projection amount and a horizontal projection amount of the target object to obtain an object region of the target object, selects a reference point within the object region, and obtains the moving trace by means of a location of the reference point in each image of the image sequence.

In an embodiment of the invention, the target detection module obtains an ROI according to the ear side location region, performs an image subtraction algorithm on the ROI in each of a current image and a reference image in the image sequence to obtain a target region image, and filters out noise in the target region image by means of the ROI in the reference image to obtain the target object.

In an embodiment of the invention, the target detection module performs an edge detection algorithm and a dilation algorithm on the ROI in the reference image to obtain a filtered region image, and performs the image subtraction algorithm on the filtered region image and the target region image to obtain the target object.

In an embodiment of the invention, the determination module determines whether a residence time during which the target object stays in the ear side location region exceeds a predetermined time and notifies the reminding module to send the reminding signal when the residence time exceeds the predetermined time.

Based on the above, by using image recognition technology, whether the driver is using a mobile phone in the vehicle is determined. Moreover, upon confirmation that the driver is using a mobile phone, a reminding message is sent in order to avoid accidents due to the driver's distraction.

To make the above features and advantages of the invention more comprehensible, embodiments accompanied with drawings are described in detail as follows.

### BRIEF DESCRIPTION OF THE DRAWINGS

FIG. 1 is a schematic view of an electronic apparatus for a vehicle according to an embodiment of the invention.

FIG. 2 is a flow chart of a warning method for driving a vehicle according to an embodiment of the invention.

FIG. 3 is a flow chart of another warning method for driving a vehicle according to an embodiment of the invention.

FIG. 4 is a schematic view of an image according to an embodiment of the invention.

FIG. 5A to FIG. 5E are schematic views of detecting a target object according to an embodiment of the invention.

FIG. 6 is a schematic view of an image processing module according to an embodiment of the invention.

### DETAILED DESCRIPTION OF DISCLOSED EMBODIMENTS

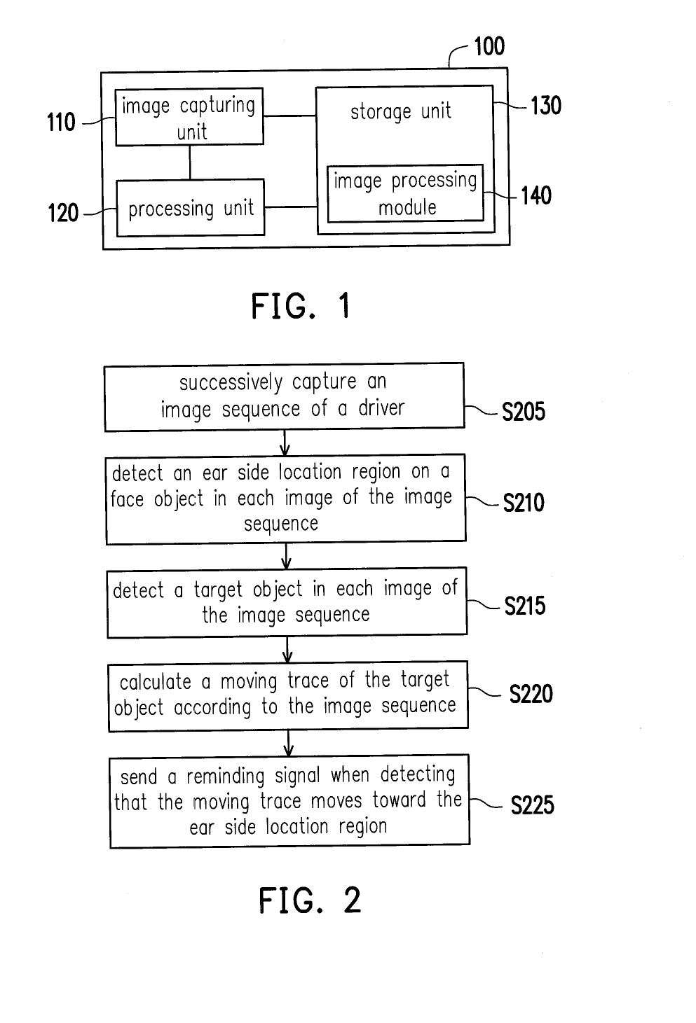

FIG. 1 is a schematic view of an electronic apparatus for a vehicle according to an embodiment of the invention. Referring to FIG. 1, an electronic apparatus 100 for a vehicle includes an image capturing unit 110, a processing unit 120, a storage unit 130 and an image processing module 140. In the present embodiment, the electronic apparatus 100 for a vehicle is an independent apparatus mounted in front of a driver's seat in the vehicle so as to take images of the driver. In other embodiments, the electronic apparatus 100 for a vehicle may be incorporated into the vehicle. The electronic apparatus 100 for a vehicle has, for example, a structure of an embedded system, so that it may be embedded in any electronic apparatus.

The image capturing unit 110 captures an image sequence (including one or more images) of the driver, and stores the image sequence in the storage unit 130. The image capturing unit 110 is, for example, a video camera or camera having a charge coupled device (CCD) lens, a complementary metal oxide semiconductor transistor (CMOS) lens, or an infrared lens, but is not limited thereto.

The processing unit 120 is, for example, a central processing unit (CPU), a graphics processing unit (GPU), or other programmable devices such as a microprocessor, a digital signal processor (DSP) and so on. The processing unit 120 is coupled to the storage unit 130 to obtain the image sequence captured by the image capturing unit 110. In addition, the processing unit 120 executes the image processing module 140 to perform a recognition process of the image sequence. For example, after taking an image, the image capturing unit 110 stores the image in the storage unit 130 via its input/output (I/O) unit, and the processing unit 120 obtains the image from the storage unit 130 to execute an image processing procedure.

The storage unit 130 is, for example, a random access memory (RAM), a read-only memory (ROM), a flash memory, or a magnetic disk storage device.

In the present embodiment, the image processing module 140 is, for example, a code segment written in a computer programming language. The code segment stores in the storage unit 130 (or another storage unit), for example, and includes a plurality of commands. And the processing unit 120 executes the code segment. In addition, in other embodiments, the image processing module 140 may be a hardware component consisting of one or more circuits. The image processing module 140 is coupled to the processing unit 120 and driven by the processing unit 120.

In addition, in other embodiments, the image capturing unit 110 also has an illumination element to supply light when there is insufficient light so as to ensure clarity of its captured images.

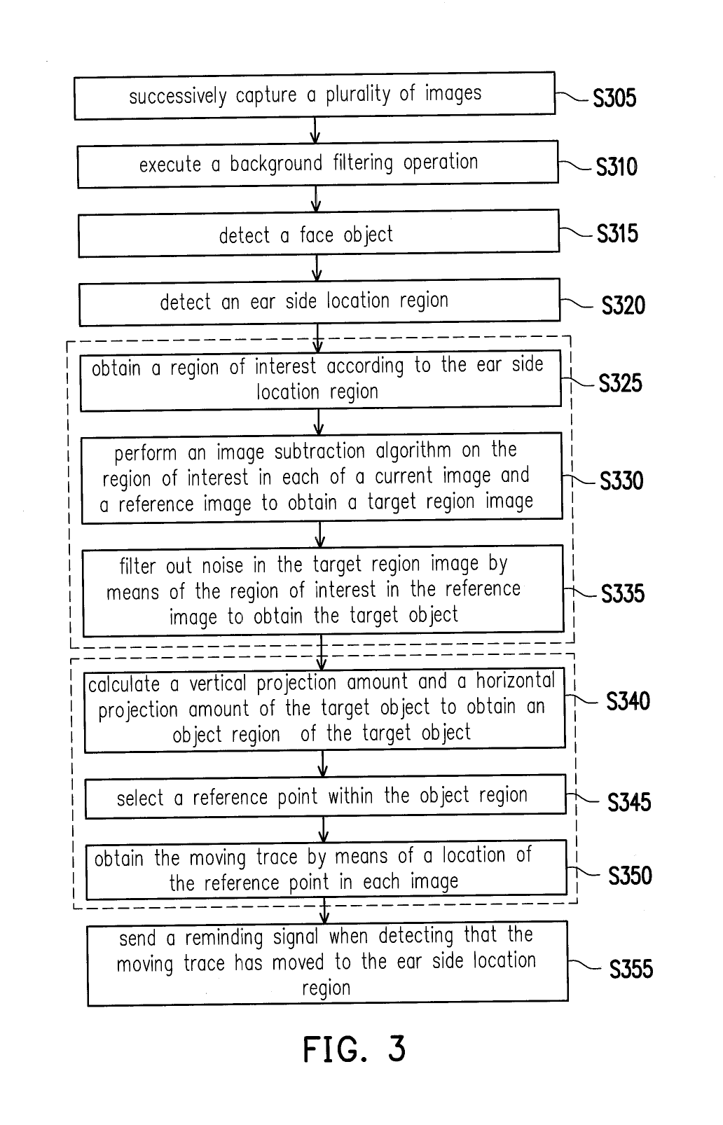

Steps of the warning method for driving a vehicle in a case of using the electronic apparatus 100 for a vehicle are described in detail below. FIG. 2 is a flow chart of a warning method for driving a vehicle according to an embodiment of the invention. Referring to both FIG. 1 and FIG. 2, the image sequence of the driver is successively captured by the image capturing unit 110 (step S205). Next, the image processing module 140 starts to perform the image processing procedure on each image of the image sequence.

The image processing module 140 detects an ear side location region on a face object in each image of the image sequence (step S210). In the present embodiment, in order to obtain the ear side location region more precisely, after obtaining the face object, the image processing module 140 searches for a nostrils object on the face object, and further searches for the ear side location region in a horizontal direction based on a location of the nostrils object. For example, the image processing module 140 searches for edges of both cheeks on left and right sides of the nostrils object. Then, according to statistic relative positions of the face and the ears, the ear side location regions on the left and right sides are obtained by using the found edges as reference.

Next, the image processing module 140 detects a target object in each image of the image sequence (step S215). Here, the target object is, for example, a mobile phone. In other words, the image processing module 140 detects the mobile phone in each image. After obtaining the target object, the image processing module 140 calculates a moving trace of the target object according to the image sequence (step S220). For example, the image processing module 140 uses one point of the target object as a reference point, and performs statistics on locations of the reference point in each image to obtain the moving trace of the target object. When detecting that the moving trace moves toward the ear side location region, the image processing module 140 sends a reminding signal (step S225).

Here, the image processing module 140 may further determine whether a residence time during which the target object stays in the ear side location region exceeds a predetermined time (e.g. 3 seconds) and send the reminding signal when the residence time exceeds the predetermined time. That is to say, in the event that the residence time during which the target object stays in the ear side location region exceeds the predetermined time, it may imply that the driver is using the mobile phone while driving.

Another embodiment is illustrated in the following.

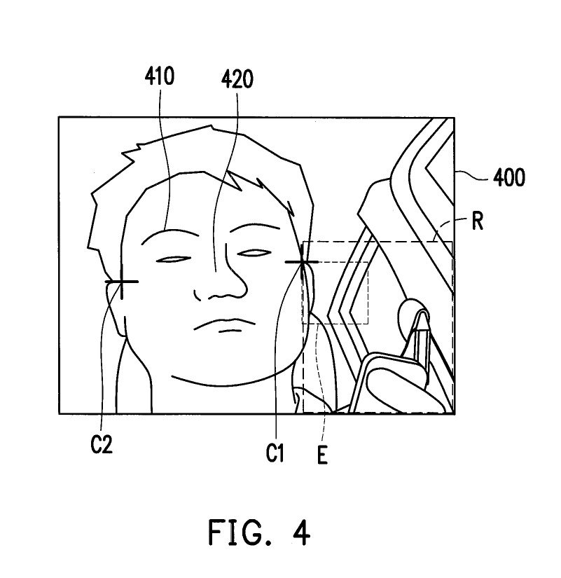

FIG. 3 is a flow chart of another warning method for driving a vehicle according to an embodiment of the invention. Referring to both FIG. 1 and FIG. 3, first, a plurality of images of the driver are successively captured by the image capturing unit 110 (step S305). Next, the image processing module 140 executes a background filtering operation (step S310). For example, an N-th image and an (N+1)-th image are subjected to a differencing process. Then, the images with the background filtered out are converted into grayscale images for the subsequent procedures.

After that, the image processing module 140 detects facial characteristics in the images, thereby obtaining the face object (step S315). For example, the storage unit 130 stores a characteristics database, and the characteristics database includes patterns of facial characteristics. By performing comparison with the patterns of facial characteristics between the images and the characteristics database, the image processing module 140 obtains the face object in each of the images. In a preferred embodiment, the face in each image may be obtained using the AdaBoost algorithm or other conventional face recognition algorithms (e.g. face recognition using Haar-like features). Nonetheless, the above means are merely examples and the invention is not limited thereto.

Then, the image processing module 140 detects the ear side location region on the face object in each image (step S320). For example, the image processing module 140 searches for the nostrils object on the face object, and then searches for the edges of both cheeks along left and right sides of the nostrils object. After that, according to statistic relative positions of the face and the ears, the ear side location regions on the left and right sides are obtained by using the found edges as reference. Then, the image processing module 140 obtains a region of interest (ROI) according to the ear side location regions (step S325).

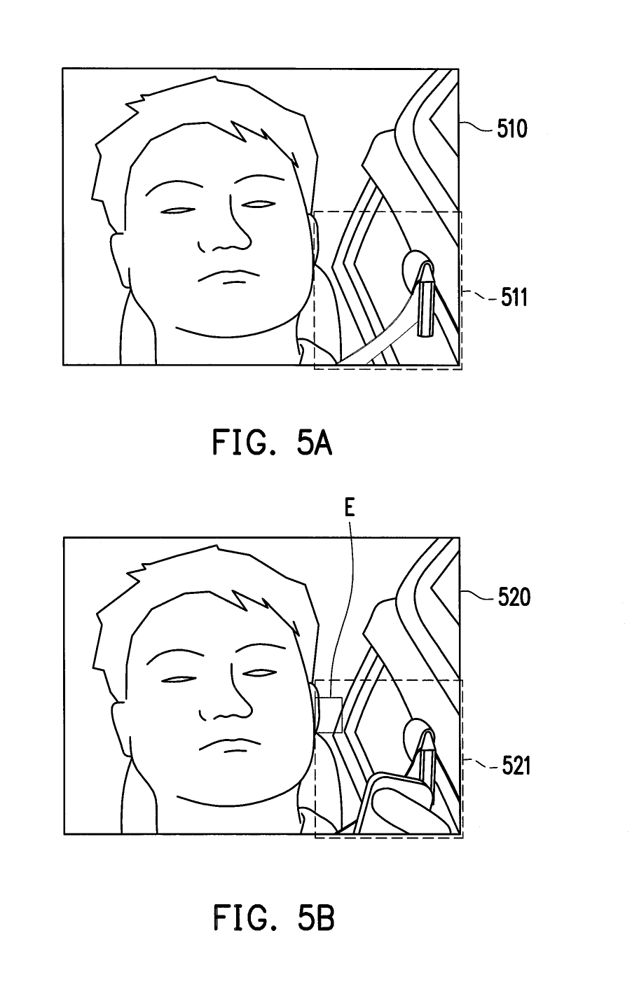

FIG. 4, for example, is a schematic view of an image according to an embodiment of the invention. After detecting a face object 410 in an image 400, the image processing module 140 obtains a nostrils object 420, and then finds edges C1 and C2 on left and right sides of the nostrils object 420, thus obtaining the ear side location regions by using the edges C1 and C2 as reference. For the convenience of illustration, only the edge C1 of one cheek is described herein. Nonetheless, the same situation exists at the edge C2 of the other cheek. Coordinates of the edge C1 are used as reference, and an ear side location region E is obtained within a predetermined object region. Then, according to the ear side location region E, a ROI R is obtained within another predetermined object region.

Next, the image processing module 140 performs an image subtraction algorithm on the ROI in each of a current image and a reference image (which may be a preceding image such as a previous image or a previous N-th image before the current image, or may be any predetermined image) to obtain a target region image (step S330), and filters out noise in the target region image by means of the ROI in the reference image to obtain the target object (step S335).

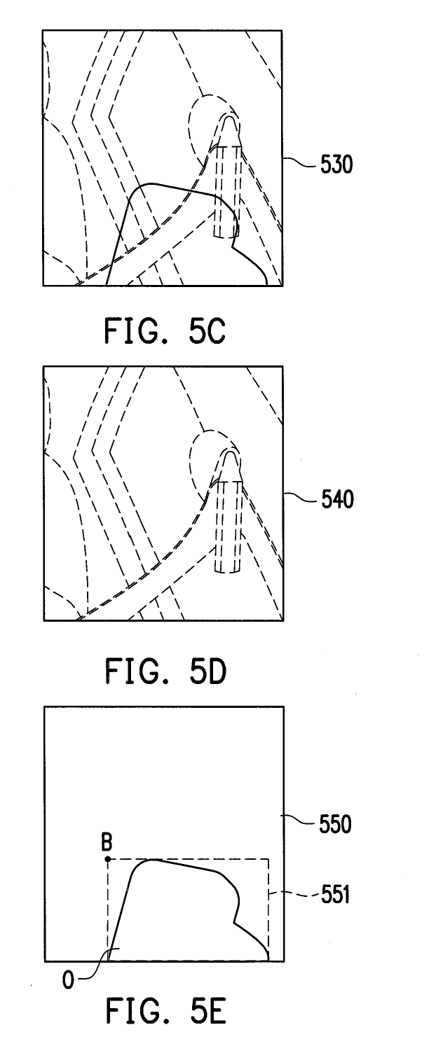

FIG. 5A to FIG. 5E, for example, are schematic views of detecting a target object according to an embodiment of the invention. For simplicity, the gray scale of FIG. 5A to FIG. 5E is omitted and only the edge of the gray scale is depicted herein for illustration. FIG. 5A shows a reference image 510 which illustrates an ROI 511. FIG. 5B shows a current image 520 captured by the image capturing unit 110, which illustrates an ROI 521 and the ear side location region E. FIG. 5C shows a target region image 530. FIG. 5D shows a filtered region image 540. FIG. 5E shows a region image 550 having a target object O.

Specifically, an image subtraction algorithm is performed on the ROI 511 in the reference image 510 and the ROI 521 in the current image 520, thereby obtaining the target region image 530 indicating the difference between the above two images. That is to say, the target region image 530 is a result of performing the image subtraction algorithm on the ROI 511 and the ROI 521. In the target region image 530, dashed lines represent noise other than the target object. In order to filter out the noise to obtain the target object, an edge detection algorithm, a dilation algorithm and so on are performed on the ROI 511 in the reference image 510 to obtain the filtered region image 540. Then, an image subtraction algorithm is performed on the target region image 530 and the filtered region image 540, thereby obtaining the region image 550 having the target object O as shown by FIG. 5E.

Referring back to FIG. 3, after obtaining the target object, the image processing module 140 calculates a vertical projection amount and a horizontal projection amount of the target object to obtain an object region of the target object (step S340). Specifically, the image processing module 140 calculates the vertical projection amount of the target object to obtain a length of the target object on the vertical axis, and also calculates the horizontal projection amount of the target object to obtain a width of the target object on the horizontal axis. By means of the length and width, the object region of the target object is obtained.

After that, the image processing module 140 selects a reference point within the object region (step S345). Moreover, by using the same point in the target object in subsequent images as the reference point, the moving trace is obtained by means of a location of the reference point in each image (step S350).

In the case of FIG. 5E, for example, the length and width of the target object O are calculated to obtain an object region 551, and an uppermost left point B of the object region 551 is used as the reference point. The uppermost left points of the object regions of the target objects in other subsequent images are also used as reference points. Accordingly, from the reference points in these images, the moving trace of the target object is obtained. The above case using the uppermost left point of the object region as the reference point is merely an example and the invention is not limited thereto. After that, when detecting that the moving trace has moved to the ear side location region, the image processing module 140 sends a reminding signal (step S355). In addition, the image processing module 140 is also capable of detecting whether the moving trace is moving toward the ear side location region so as to identify the target object (which is a mobile phone in the present embodiment) more precisely.

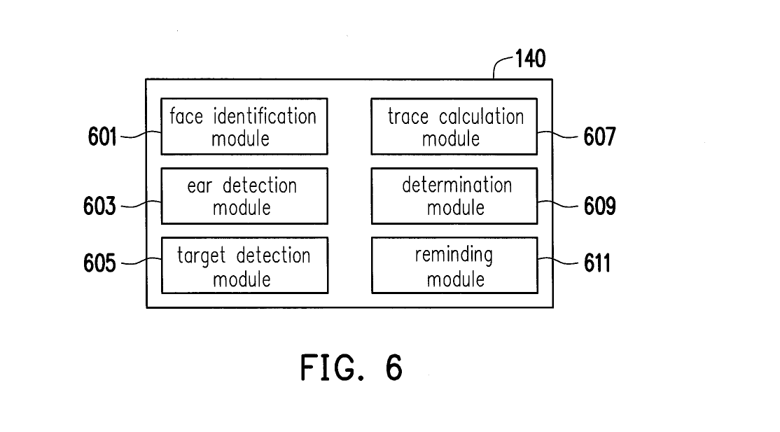

An example is given below for illustration of the structure of the image processing module 140. FIG. 6 is a schematic view of an image processing module according to an embodiment of the invention. Referring to FIG. 4, the image processing module 140 includes a face identification module 601, an ear detection module 603, a target detection module 605, a trace calculation module 607, a determination module 609 and a reminding module 611.

The face identification module 601 obtains the face object by means of a face recognition algorithm, and searches for the nostrils object on the face object. The face identification module 601 may, for example, detect the face object in an image by using the AdaBoost algorithm or other conventional face recognition algorithms (e.g. face recognition using Haar-like features).

The ear detection module 603 detects the ear side location region on the face object in the image. The ear detection module 603 may, for example, perform a comparison between ear characteristics obtained from the image and patterns of ear characteristics that have been stored in advance in a characteristics database, thereby obtaining the ear side location regions on the left and right sides. In addition, in the event that the ear characteristics are unavailable because the ears are covered by the hair or other objects, the ear detection module 603 may have been informed of to what location on the face the ear side location region corresponds according to pattern training, thus directly obtaining the ear side location regions on the left and right sides from predetermined data. In addition, the ear detection module 603 searches for the ear side location region in a horizontal direction based on the location of the nostrils object. The ear detection module 603 may, for example, obtain the edges of both cheeks in the horizontal direction based on the location of the nostrils object, and then obtain the ear side location regions on the left and right sides from predetermined data.

The target detection module 605 detects the target object in the image. The target detection module 605 obtains an ROI according to the ear side location region, performs an image subtraction algorithm on the ROI in each of a current image and a reference image to obtain a target region image, and accordingly, filters out noise in the target region image by means of the ROI in the reference image to obtain the target object. Details thereof have been described with reference to FIG. 5A to FIG. 5E and are thus omitted here.

The trace calculation module 607 calculates the moving trace of the target object. The trace calculation module 607, for example, uses one point of the target object as a reference point, and performs statistics on the location of the reference point in each image to obtain the moving trace of the target object. The trace calculation module 607 may, for example, calculate a vertical projection amount and a horizontal projection amount of the target object to obtain an object region of the target object, select a reference point within the object region, and obtain the moving trace by means of the location of the reference point in each image.

The determination module 609 determines whether the target object has moved to the ear side location region based on the moving trace. The determination module 609 may, for example, determine whether a location of the reference point obtained by the trace calculation module 607 is located in the ear side location region. In addition, the determination module 609 may predict whether the target object will move to the ear side location region based on the moving trace. The above are merely examples and the invention is not limited thereto.

The reminding module 611 sends a reminding signal when the moving trace has moved to the ear side location region. The reminding module 611 may, for example, send a voice or a vibration reminding signal when receiving a command or an order from the determination module 609.

The electronic apparatus 100 for a vehicle detects whether the driver is using the mobile phone by means of image recognition technology. In addition, the electronic apparatus 100 for a vehicle may also have a sleep detection mechanism to detect whether the driver is in a drowsy driving state.

In summary, the invention locates a target object in an image using image recognition technology, and calculates a moving trace of the target object in successive multiple images, thereby determining whether a driver is using a mobile phone in the vehicle. Moreover, upon confirmation that the driver is using a mobile phone, a reminding message is sent in order to avoid accidents due to the driver's distraction.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A warning method for driving a vehicle, utilized in an electronic apparatus for a vehicle, the method comprising:
successively capturing an image sequence of a driver by an image capturing unit;
detecting an ear side location region on a face object in each image of the image sequence;
detecting a target object in each image of the image sequence;
calculating a moving trace of the target object according to the image sequence; and
sending a reminding signal when the moving trace moves toward the ear side location region.

2. The warning method as claimed in claim 1, wherein the step of detecting the ear side location region on the face object in each image of the image sequence comprises:
obtaining the face object by means of a face recognition algorithm;
searching for a nostrils object on the face object; and
searching for the ear side location region in a horizontal direction based on a location of the nostrils object.

3. The warning method as claimed in claim 1, wherein the step of calculating the moving trace of the target object comprises:
calculating a vertical projection amount and a horizontal projection amount of the target object to obtain an object region of the target object;
selecting a reference point within the object region; and
obtaining the moving trace by means of a location of the reference point in each image of the image sequence.

4. The warning method as claimed in claim 1, wherein the step of sending the reminding signal when the moving trace moves toward the ear side location region, further comprising:
determining whether a residence time during which the target object stays in the ear side location region exceeds a predetermined time; and
sending the reminding signal when the residence time exceeds the predetermined time.

5. The warning method as claimed in claim 1, wherein the step of detecting the target object comprises:
obtaining a region of interest (ROI) according to the ear side location region;
performing an image subtraction algorithm on the ROI in each of a current image and a reference image in the image sequence to obtain a target region image; and
filtering out noise in the target region image by means of the ROI in the reference image to obtain the target object.

6. The warning method as claimed in claim 5, wherein the step of filtering out noise in the target region image by means of the ROI in the reference image to obtain the target object comprises:
performing an edge detection algorithm and a dilation algorithm on the ROI in the reference image to obtain a filtered region image; and
performing the image subtraction algorithm on the filtered region image and the target region image to obtain the target object.

7. An electronic apparatus for a vehicle, comprising:
an image capturing unit successively capturing an image sequence of a driver;
a storage unit storing the image sequence; and
a processing unit coupled to the storage unit to obtain the image sequence and configured to performing an image processing module;
wherein the image processing module detects an ear side location region on a face object in each image of the image sequence, detects a target object in each image of the image sequence, calculates a moving trace of the target object, determines whether the target object moves toward the ear side location region based on the moving trace, and sends a reminding signal when the moving trace moves toward the ear side location region.

8. The electronic apparatus for a vehicle as claimed in claim 7, wherein the image processing module comprises:
an ear detection module detecting the ear side location region on the face object in each image of the image sequence;
a target detection module detecting the target object in each image of the image sequence;
a trace calculation module calculating the moving trace of the target object;
a determination module determining whether the target object moves toward the ear side location region based on the moving trace; and
a reminding module sending a reminding signal when the moving trace moves toward the ear side location region.

9. The electronic apparatus for a vehicle as claimed in claim 8, wherein the image processing module further comprises:
a face identification module obtaining the face object by means of a face recognition algorithm, and searching for the nostrils object on the face object;
wherein the ear detection module searches for the ear side location region in a horizontal direction based on a location of the nostrils object.

10. The electronic apparatus for a vehicle as claimed in claim 8, wherein the trace calculation module calculates a vertical projection amount and a horizontal projection amount of the target object to obtain an object region of the target object, selects a reference point within the object region, and obtains the moving trace by means of a location of the reference point in each image of the image sequence.

11. The electronic apparatus for a vehicle as claimed in claim 8, wherein the target detection module obtains an ROI according to the ear side location region, performs an image subtraction algorithm on the ROI in each of a current image and a reference image in the image sequence to obtain a target region image, and filters out noise in the target region image by means of the ROI in the reference image to obtain the target object.

12. The electronic apparatus for a vehicle as claimed in claim 11, wherein the target detection module performs an edge detection algorithm and a dilation algorithm on the ROI in the reference image to obtain a filtered region image, and performs the image subtraction algorithm on the filtered region image and the target region image to obtain the target object.

13. The electronic apparatus for a vehicle as claimed in claim 8, wherein the determination module determines whether a residence time during which the target object stays in the ear side location region exceeds a predetermined time, and sends the reminding signal when the residence time exceeds the predetermined time.
